(19) United States
(12) Patent Application Publication
(10) Pub. No.: US 2018/0196314 A1
(43) Pub. Date: Jul. 12, 2018

(54) LIQUID CRYSTAL DISPLAY DEVICE

(71) Applicant: Japan Display Inc., Minato-ku (JP)

(72) Inventors: Keiji TAGO, Minato-ku (JP); Saori Sugiyama, Minato-ku (JP)

(73) Assignee: Japan Display Inc., Minato-ku (JP)

(21) Appl. No.: 15/839,923

(22) Filed: Dec. 13, 2017

(30) Foreign Application Priority Data
Jan. 6, 2017 (JP) 2017-000958

(51) Int. Cl. G02F 1/1337; G02F 1/1333; G02F 1/1343

(52) U.S. Cl. CPC G02F 1/133711; G09G 2310/0264; G02F 1/1343; G02F 1/133345

(57) ABSTRACT

The purpose of the invention is to suppress a color shift when the screen is viewed in an oblique direction. The structure to countermeasure the problem is: A liquid crystal display device comprising; a liquid crystal layer is sealed between a first substrate and a second substrate, a first insulating film including a silicon oxide film (SiO) on the first substrate, a second insulating film including a silicon nitride film (SiN) covering the first insulating film, a third insulating film including a silicon oxide film (SiO) covering the second insulating film, wherein a thickness of the second insulating film is between 190 nm and 270 nm.

### CLAIM OF PRIORITY

The present application claims priority from Japanese Patent Application JP 2017-000958 filed on Jan. 6, 2017, the content of which is hereby incorporated by reference into this application.

### BACKGROUND OF THE INVENTION

### (1) Field of the Invention

The present invention relates to a liquid crystal display device and countermeasures a phenomenon that the screen becomes reddish when it is viewed in an oblique direction.

### (2) Description of the Related Art

A liquid crystal display device comprises a TFT substrate where pixels, each has a pixel electrode and a Thin film transistor (TFT), are arranged in a matrix form; a counter substrate set opposing to the TFT substrate; a liquid crystal layer sandwiched by the TFT substrate and the counter substrate. Images are formed by controlling a transmittance of light by liquid crystal molecules in each of the pixels. Since liquid crystal display devices are flat and light, their applications are expanding. Small sized liquid crystal displays are widely used in cellar phones or DSCs (Digital Still Camera).

Since the liquid crystal is not self-illuminant, the liquid crystal display device needs a backlight. When light from the back light passes through the liquid crystal display device, images of the liquid crystal display occasionally get colored because of interference of light. Further, coloring of the screen arises when the external light intrudes into the liquid crystal panel, reflects in the liquid crystal display device, and consequently when an interference of light occurs. Such a coloring deteriorates the quality of images.

The TFT is set in each of the pixels in the liquid crystal display device. The patent document 1 (Japanese patent laid open 2015-210296) discloses to suppress the coloring of the screen due to interference by controlling a thickness of the gate insulating film in the TFT.

### SUMMARY OF THE INVENTION

The liquid crystal display device has a problem of a viewing angle. The viewing angle is a phenomenon that brightness or color becomes different between when the screen is viewed in the normal direction to the screen and viewed in an oblique angle to the screen. There are several ways to adjust the white color temperature when the screen is viewed in the normal direction. There is, however, a phenomenon that degree of white becomes different between when the screen is viewed at a right angel to the screen and viewed in an oblique angle to the screen.

The IPS (In Plane Switching) type liquid crystal display device, which drives the liquid crystal molecules by in plane field, has a superior viewing angle characteristic. However, a requirement for the quality of the display has become severe, thus, even in the IPS type liquid crystal display device, difference of white between when the screen is viewed in the normal direction to the screen and when the screen is viewed in an oblique angle to the screen has become a problem.

Specifically, the phenomenon that the white when viewed in the normal direction to the screen becomes reddish when it is viewed in an oblique direction to the screen is an important problem. The purpose of the present invention is to countermeasure the color shift that the white when viewed in the normal direction to the screen changes to reddish when it is viewed in an oblique direction to the screen.

The present invention solves the above problem; the concrete measures are as follows: A liquid crystal display device comprising: a liquid crystal layer is sealed between a first substrate and a second substrate, a first insulating film including a silicon oxide film (SiO) on the first substrate, a second insulating film including a silicon nitride film (SiN) covering the first insulating film, a third insulating film including a silicon oxide film (SiO) covering the second insulating film, wherein a thickness of the second insulating film is between 190 nm and 270 nm.

### BRIEF DESCRIPTION OF THE DRAWINGS

FIG. 1 is a plan view of the liquid crystal display device that the present invention is applied;

FIG. 2 is a cross sectional view of the display area of the liquid crystal display device;

FIG. 3 is a conceptual model that shows the reddish phenomenon;

FIG. 4 is a diagram that the phenomenon of FIG. 3 is applied to the color coordinates of the xy chromaticity diagram;

FIG. 5 is a definition of the azimuth;

FIG. 6 is an evaluation of color shift according to the viewing angles in samples where the thickness of the interlayer insulting film is changed;

FIG. 7 is a chromaticity diagram that shows color shifts when the polar angle is 70 degree and the azimuth is 270 degree;

FIG. 8 is a chromaticity diagram that shows color shifts when the polar angle is 70 degree and the azimuth is 315 degree;

FIG. 9 is a diagram to show an amount of shift in the color coordinates when thickness of the interlayer insulating film is changed;

FIG. 10 is a table that shows thicknesses and indices of layers, which can affect the reddish, of the TFT substrate;

FIG. 11 is a table that shows how color coordinates changes according to a thickness of the interlayer insulating film;

FIG. 12 is a chromaticity diagram according to the table of FIG. 11;

FIG. 13 is an example of the driving voltage;

FIG. 14 is a diagram that shows the change of color coordinates when the azimuth is 270 degree between the polar angle is zero and the polar angle is 70 degree of the sample B1 and the sample B2 of FIG. 13;

FIG. 15 is a diagram that the same evaluation as FIG. 14 is made to the case of the azimuth is 315 degree;

FIG. 16 is a table that shows color coordinates of the white in different viewing angles in various samples;

FIG. 17 is a chromaticity diagram that shows color shifts when the polar angle is 70 degree and the azimuth is 270 degree;

FIG. 18 is a chromaticity diagram that shows color shifts when the polar angle is 70 degree and the azimuth is 315 degree.

### DETAILED DESCRIPTION OF THE PREFERRED EMBODIMENTS

The invention is described in detail by the following embodiment.

### First Embodiment

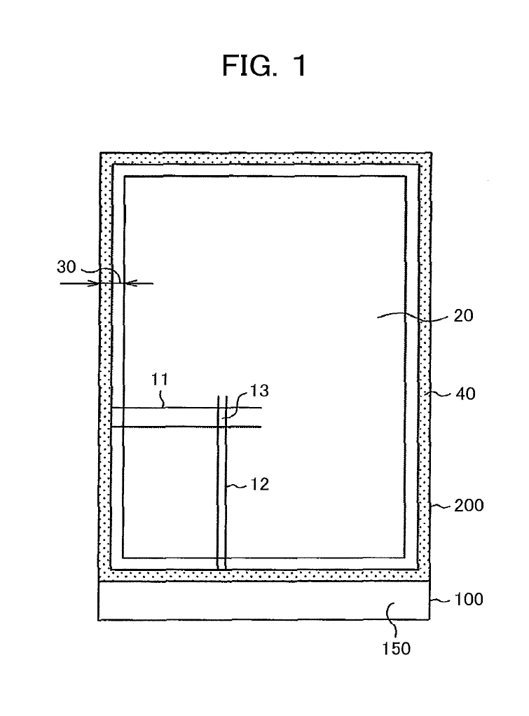

FIG. 1 is a plan view of a liquid crystal display device, which is used in e.g. a cellar phone. In FIG. 1, the TFT substrate 100 and the counter substrate 200 adhere to each other via the seal material 40. The liquid crystal layer is sandwiched between the TFT substrate 100 and the counter substrate 200. The display area 20 is formed where the TFT substrate 100 and the counter substrate 200 overlap to each other; the frame area 30 is outside of the display area 20.

The portion where the TFT substrate and the counter substrate don't overlap is the terminal area 150. The driver IC that drives the liquid crystal display device is installed in the terminal area. The flexible wiring substrate is connected to the terminal area to supply powers and signals to the liquid crystal display device. In the display area 20 of FIG. 1, scanning lines 11 extend in lateral direction and arranged in longitudinal direction; the video signal lines 12 extend in longitudinal direction and arranged in lateral direction. A pixel is formed in an area surrounded by the scanning lines 11 and the video signal lines 12.

A back light is set behind the display device of FIG. 1. When the liquid crystal display device of FIG. 1 is installed in an apparatus like a cellar phone, a protective glass (front window) is set in front of the liquid crystal display device. The plan views of the liquid crystal display device, herein after, include the protective glass.

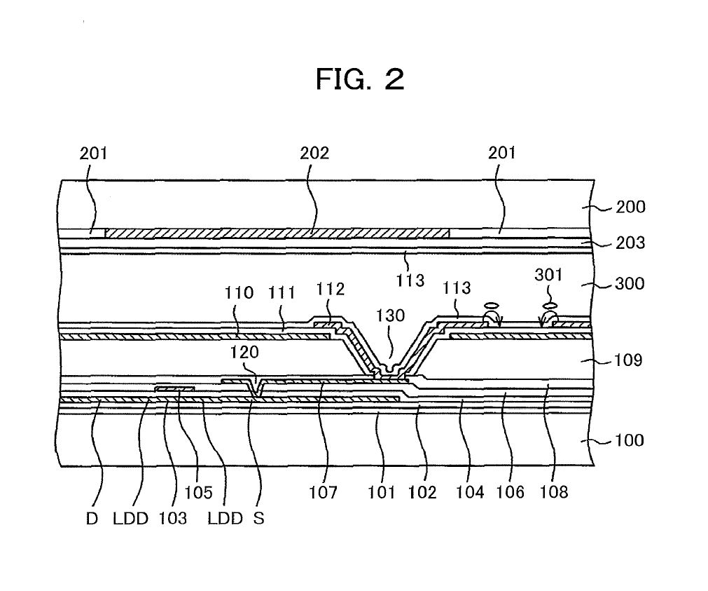

FIG. 2 is a cross sectional view of the display area of the liquid crystal display device. There are several systems in the IPS type liquid crystal display device; out of them, the FFS (Fringe Field Switching) system is now in the mainstream. The FFS has a structure that: the pixel electrode of transparent electrode having plural slits is set over the solid plane transparent conductive film at a side of the liquid crystal layer via the capacitive insulating film. The structure of the FFS is explained below.

The TFT of FIG. 2 is a so called top gate type TFT and the LTPS (Low Temperature Poly-Silicon) is used as a semiconductor layer. On the other hand, if the a-Si (amorphous Silicon) is used as a semiconductor layer, the TFT tends to be a bottom gate type. In the explanation below, the top gate type TFT is taken, however, the present invention can be applied to the bottom gate type TFT, too.

In FIG. 2, the first undercoat 101 formed by silicon nitride SiN and the second undercoat 102 formed by silicon oxide SiO are formed by CVD (Chemical Vapor Deposition) on the glass substrate 100. The role of the first undercoat 101 and the second undercoat 102 is to prevent the semiconductor layer 103 from being contaminated by impurities from the glass substrate 100.

The semiconductor layer 103 is formed on the second undercoat 102. The semiconductor 103 is made as that: an amorphous silicon film a-Si is formed on the second undercoat 102 by CVD; the amorphous silicon film a-Si is transformed to the poly-silicon film by applying excimer laser; the poly-silicon layer is patterned by lithography.

The gate insulating film 104 is formed on the semiconductor layer 103. The gate insulating film 104 is formed by SiO using TEOS (Tetraethyl orthosilicate) as a material. The gate insulating film 104 is also formed by CVD. The gate electrode 105 is formed on the gate insulating film 104. The scanning line 10 in FIG. 2 works as the gate electrode 105. The gate electrode 105 is formed by e.g. MoW (Molybdenum/Tungsten) film. If the resistance of the scanning line 10 or the gate electrode 105 must be low, Al alloy is used.

The gate electrode is patterned by photolithography. At this patterning, the source S or the drain D of n+ areas are formed in the poly-silicon layer 103 by doping high density of impurity as e.g. phosphors (P) or boron (B) by ion implantation. During the patterning, the photo resist for the gate electrode 105 is utilized to form LDD (Lightly Doped Drain), which is formed between the channel of the poly-Si and the source S and between the channel of the poly-Si and the drain D.

After that, the interlayer insulating film 106 is formed by SiN covering the gate electrode 105. The interlayer insulating film 106 is to insulate between the gate electrode 105 (or scanning line 10) and the contact electrode 107. The through hole 120 is formed in the interlayer insulating film 105 and the gate insulating film 104 to connect the source S of the semiconductor layer 103 and the contact electrode 107. The photolithography for the through hole 120 in the interlayer insulating film 106 and in the gate insulating film 104 is commonly applied to the two layers.

The contact electrode 107 is formed on the interlayer insulating film 106. The contact electrode 107 connects with the pixel electrode 112 through the through hole 130. The drain D of the TFT connects with the video signal line 12 through the through hole.

The contact electrode 107 and the video signal line 20 are formed on the same layer and formed simultaneously. The contact electrode 107 and the video signal line 12 are formed by e.g. AlSi alloy to decrease the electric resistance. The AlSi alloy has problems as generating hillocks or defusing of Al in other layers, thus, the AlSi is sandwiched by a barrier layer and a cap layer, both are formed by e.g. MoW.

The inorganic passivation film (insulating film) 108 of SiO is formed covering the contact electrode 107 to protect the entire TFT. The inorganic passivation film is formed by CVD, the same process as the second undercoat 102. The organic passivation film 109 is formed covering the inorganic passivation film 108. The organic passivation film 109 is formed by photo sensitive acrylic. The organic passivation film 109 can be formed not only by acrylic but also by silicone resin, epoxy resin, polyimide resin, etc. The organic passivation film 109 is made thick since it has a role of a flattening film. Thickness of the organic passivation film 109 is 1-4 μm, and often it is approximately 2 μm.

The through hole 130 is formed in the organic passivation film 109 to connect the pixel electrode 110 and the contact electrode 107. The photo sensitive material is used for the organic passivation film 109. The photo sensitive material is coated on the inorganic passivation film 108, then it is exposed using a mask; the exposed area of the photo sensitive material dissolves in certain developer. Therefore, forming of photo resist is eliminated by using the photo sensitive material. After the through hole 130 is formed in the organic passivation film 109, the organic passivation film 109 is baked at approximately 230 centigrade, thus, the organic passivation film 109 is completed.

After that, the ITO (Indium Tin Oxide) is formed by sputtering on the organic passivation film 109 to form the common electrode 110; the ITO is eliminated from the through hole 130 and its surroundings. The common electrode 110 can be formed in common in plural pixels. After that, SiN is formed on entire area to form the second interlayer insulating film 111. Subsequently, the through hole is formed in the second interlayer insulating film 111 and the inorganic passivation film 108 to connect the pixel electrode 112 and the contact electrode 107 at the inside of the through hole 130.

After that, the ITO is formed by sputtering and is patterned to form the pixel electrode 112. The plan view of the pixel electrode is comb shaped or stripe shaped. A material for the alignment film 113 is formed on the pixel electrode 112 by flexographic printing or by inkjet; subsequently, the material is baked to form the alignment film 113. A rubbing method or a photo alignment method using UV light is used for the alignment process for the alignment film 113.

When a voltage is applied between the pixel electrode 112 and the common electrode 110, a line of force shown in FIG. 2 is generated. The line of force rotates the liquid crystal molecules 301 to control the transmittance of light in individual pixels, thus, images are formed.

In FIG. 2, the counter substrate 200 is set opposing to the TFT substrate 100 sandwiching the liquid crystal layer 300. Color filters 201 are formed inside of the counter substrate 200. Either one of the red color filter, the green color filter or the blue color filer is formed in each of the pixels, thus, color images are produced.

The black matrix 201 is formed between the color filters to prevent a color mixture between the pixels and to improve the contrast of the images. The black matrix also has a role of a light shielding film for the TFT to suppress a photo current in the TFT.

The overcoat film 203 is formed to cover the color filters 201 and the black matrix 202. The overcoat film 203 has a role to prevent the liquid crystal layer 300 from being contaminated by pigments of the color filter 201. The alignment film 113 is formed on the overcoat film 203 to determine the initial alignment of the liquid crystal molecules 301. A rubbing method or a photo alignment method is used for the alignment process of the alignment film 113, which is the same as explained at the alignment film 113 of the TFT substrate 100.

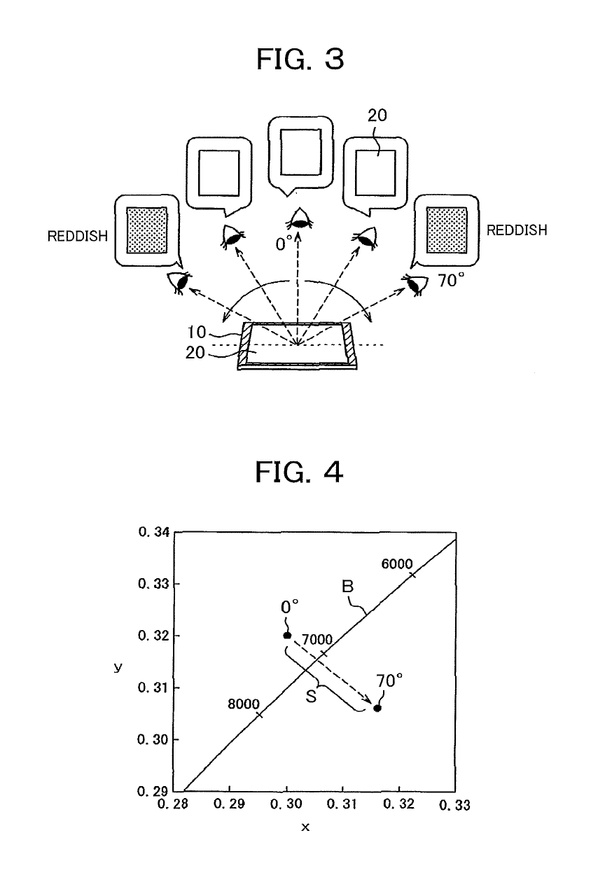

FIG. 3 is a conceptual model that shows the reddish phenomenon in this specification. An angle when the screen is viewed in an oblique direction is a polar angle in this specification. The polar angle is zero when the screen is viewed in the normal direction; then increases according to the oblique angle to the screen increases. FIG. 3 shows when white is displayed on all over the screen. The white can be seen correctly when the screen is viewed in the normal direction.

However, when the screen is viewed in an oblique angle, the screen becomes reddish according to the polar angle increases. FIG. 3 shows that the reddish of the screen appears when the angle is 70 degree or bigger. Herein after reddish is evaluated when the polar angel is 70 degree.

FIG. 4 is a diagram that the phenomenon of FIG. 3 is applied to the color coordinates of the xy chromaticity diagram. In FIG. 4, B is a curve that shows the black body radiation. The numeral on the curve B represents a color temperature of the black body. The point of zero degree represent when the screen is viewed in the normal direction. This point is in an area of approximately white on the chromaticity diagram. The point of 70 degree is a chromaticity when the screen is viewed at the polar angle is 70 degree. In FIG. 4, the reddish is intensified in going to the lower right direction. That is to say, the chromaticity changes when the polar angle is 70 degree even a white is displayed when viewed in the normal direction to the screen (poplar angel is zero). Namely, the reddish appears according to an increase in the amount of change of chromaticity coordinates in the direction of lower right in the chromaticity diagram at polar angle 70 degree in FIG. 4.

The inventors found that factors to suppress the color shift in an insignificant range are: a thickness of the interlayer insulating film; a driving voltage for each of the red pixel, the green pixel and the blue pixel; a transmitting spectrum of the color filters. Among them, the interlayer insulating film and the driving voltage are items adjusted in the side of the TFT substrate 100, while the color filter is an item adjusted in the side of the counter substrate. In addition, color filters tend to be determined according to standards as e.g. DCI (Digital Cinema Initiative) or sRGB (standard RGB), therefore, the invention is explained in regard to the thickness of the interlayer insulating film 106 and the driving voltages, which are items adjusted at the TFT substrate 100 side.

### (1) The Thickness of the Interlayer Insulating Film

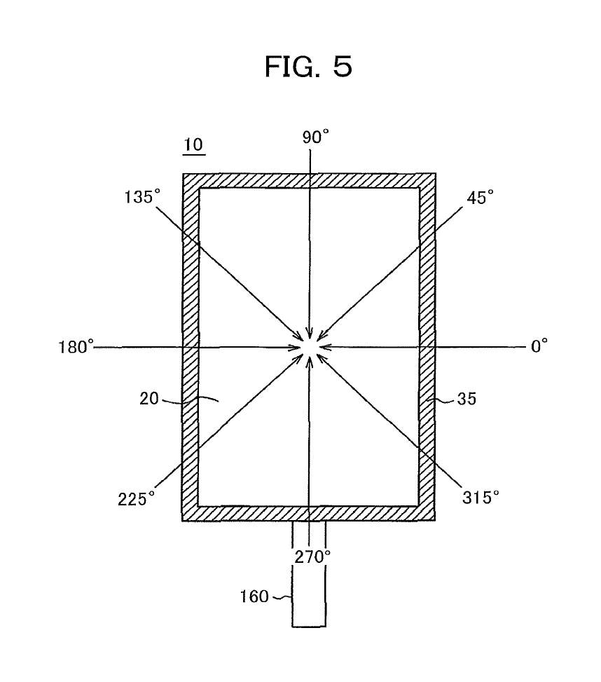

The reddish is different according to the direction that the screen is seen, namely, the azimuth. FIG. 5 is a definition of the azimuth. FIG. 5 is a liquid crystal display device 10 that is covered by the front window. The flexible wiring substrate 160 is connected to the liquid crystal display device 10 and extends in the lower direction in the figure. In FIG. 5, the azimuth is zero when a direction is 3 O'clock in clockwise on the screen, in a plan view. The azimuth is measured in counter clockwise. The inventors found the reddish is intensified when the azimuth is 270 degree and 315 degree.

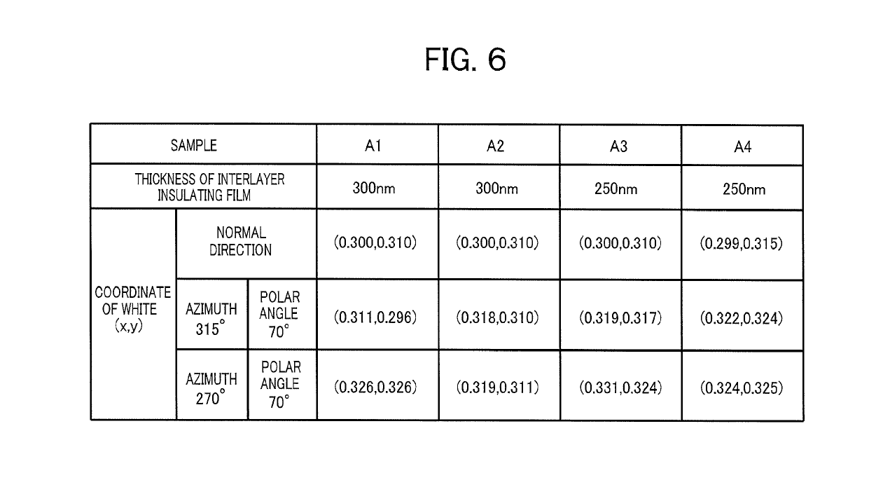

The table in FIG. 6 shows, when a white is displayed on the screen, coordinates in x, y chromaticity coordinates are written for the cases when viewed in the normal direction to the screen and when viewed in the polar angle 70 degree at the azimuth 315 degree and 270 degree in the samples each having different thickness in the interlayer insulating film, which is defined in FIG. 2.

FIG. 7 is a chromaticity diagram that shows data of the table of FIG. 6 at the case when the screen is viewed in the normal direction and when at the azimuth is 270 degree and the polar angle is 70 degree. Namely, FIG. 7 shows how the coordinates (x, y) change when the screen is viewed in the normal direction and when the screen is viewed at the azimuth 270 degree and the polar angle is 70 degree.

The reddish is intensified in going to lower right region in x, y chromaticity diagram of FIG. 7. B is coordinates of the black body radiation. As described in FIG. 7, the sample A2 substantially deviates from the black body radiation B at the azimuth 270 degree and the polar angle 70 degree; thus, the reddish is intensified. Other sample doesn't clearly show the reddish.

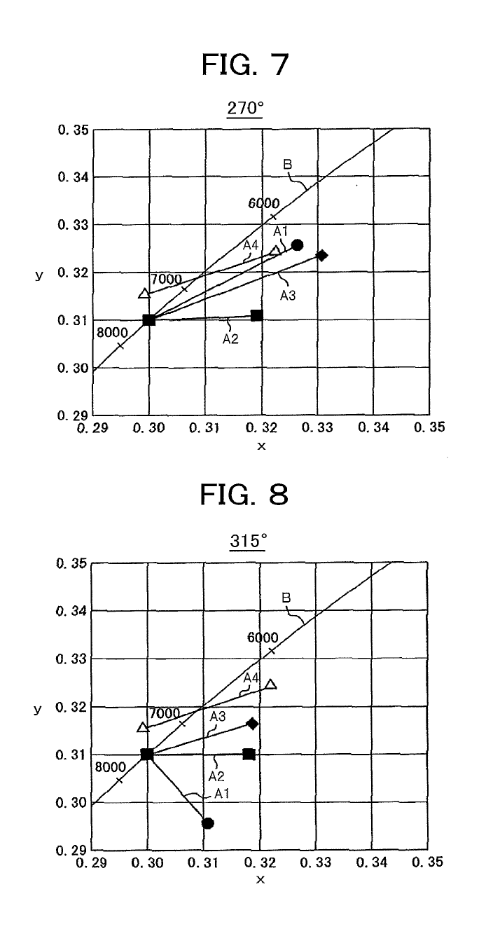

FIG. 8 is a chromaticity diagram that shows data of the table of FIG. 6 at the case when the screen is viewed in the normal direction and when in the polar angle 70 degree and the azimuth is 315 degree. Namely, FIG. 8 shows how the coordinates change when the screen is viewed in the normal direction and when the screen is viewed at the azimuth 315 degree and the polar angle is 70 degree.

In FIG. 8, the reddish is intensified at the azimuth 315 degree and the polar angle 70 degree in samples A1 and A2. On the contrary, other samples don't apparently show the reddish at the azimuth 315 degree and the polar angle 70 degree.

As shown in FIGS. 7 and 8, relative characteristics in various samples are different according to the azimuth angles. As an overall characteristic, samples A3 and A4 have the least reddish phenomenon. The difference between the group of A1, A2 and the group of A3, A4 is a difference in the thickness of the interlayer insulating film 106.

Several transparent insulating layers are used in the liquid crystal display device. When the insulating layers are laminated, interference in the transmitting light occurs since the transparent insulating films have different refractive indices. In addition, the effective thickness of the insulating layer differs according to the polar angle. Namely, interference condition becomes different since the effective thickness of the transparent insulating film changes according to the viewing angle; thus, a portion where certain wave length is intensified appears. The reddish appears at the place where the red wave length is intensified.

Among the transparent insulating films, the interlayer insulating film 106, which is formed by SiN, shown FIG. 2 has the largest effect to the reddish. The reason is that the interlayer insulating film 106 is sandwiched by the gate insulating film 104 and the inorganic passivation film 108, which have different refractive indices from the refractive index of the interlayer insulating film 106. The interlayer insulating film 106, which is mainly formed by SiN, has a refractive index of e.g. 1.85. The gate insulating film 104, which is mainly formed by SiO, has a refractive index of e.g. 1.44. The inorganic passivation film, which is mainly formed by SiO, has a refractive index of e.g. 1.49. The difference in refractive indices is as big as 0.3 or more between the interlayer insulating film 106 and the gate insulating film 104 or between the interlayer insulating film 106 and the inorganic passivation film 108.

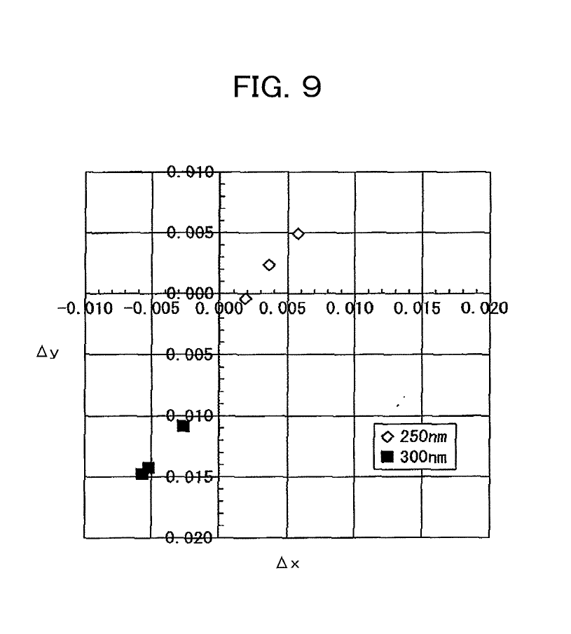

FIG. 9 is a diagram to show an amount of shift in the color coordinates when the screen is viewed in the normal direction (the polar angle is zero) to the state when the screen is viewed in the polar angle of 70 degree for the samples where only the thickness of the interlayer insulating film 106 is changed as 250 nm and 300 nm. In FIG. 9, the origin is defined by the coordinates of the white when the screen is viewed in the normal angle. The values of each of the marks of the square or the diamond shape indicate an amount of a color shift in the chromaticity coordinates. The diamond is a sample that the thickness of the interlayer insulating film is 250 nm; the square is a sample that the thickness of the interlayer insulating film is 300 nm.

In FIG. 9, when y coordinate shifts to plus direction, the color change is to green or to yellow, thus, the reddish doesn't occur; however, when y coordinate shifts to minus direction, the color shift is to red or to purple, thus, the reddish occurs. As described in FIG. 9, when the thickness of the interlayer insulating film is 250 nm, y coordinate shifts in plus direction and the amount of shift is small, thus, the white color is maintained and the reddish doesn't occur even when the screen is viewed in the polar angle of 70 degree; however, when the thickness of the interlayer insulating film 106 is 300 nm, y coordinate shifts to minus direction, thus, the reddish appears in the white.

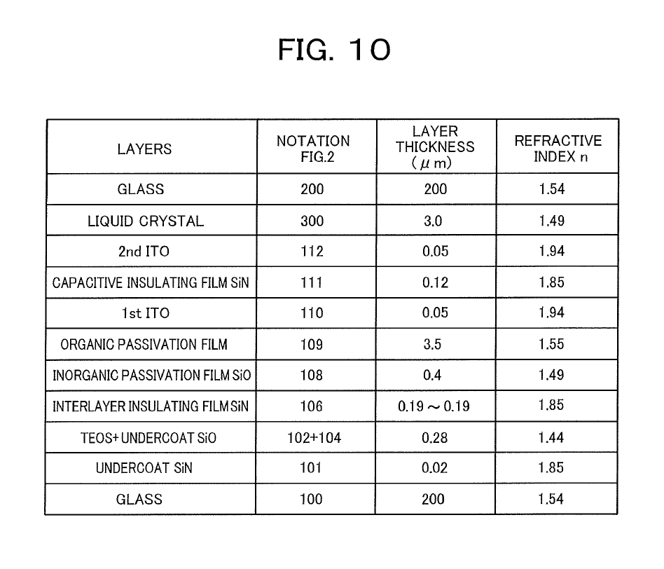

FIGS. 10-12 are the results that influence of the thickness of the interlayer insulating film 106 to the reddish is precisely evaluated. The table of FIG. 10 shows thicknesses and indices of layers of the TFT substrate that can affect the reddish. The structures of layers in FIG. 10 correspond to the layers of FIG. 2, and the same numbers as in FIG. 2 are labeled in the layers of the table of FIG. 10. The first ITO in FIG. 10 corresponds to the common electrode 110 of FIG. 2; the second ITO corresponds to the pixel electrode 112. The pre-tilt angle of the liquid crystal molecules is zero.

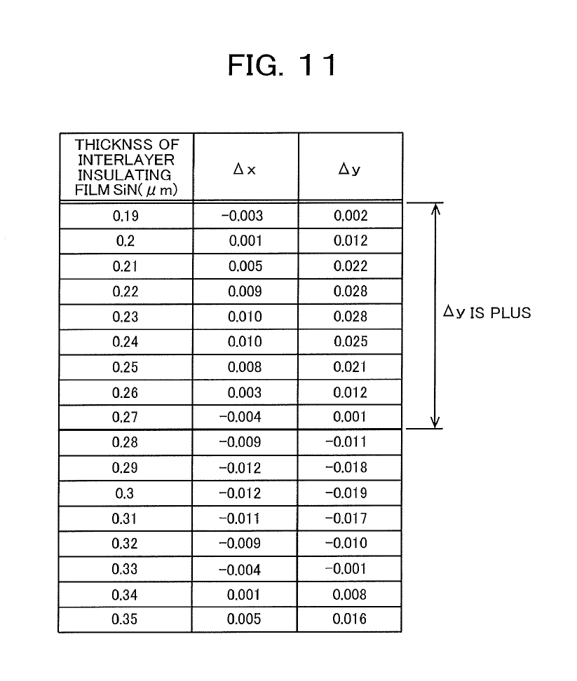

FIG. 11 is a table that shows how the color coordinates changes from the condition when the screen is viewed in the normal direction (namely, the polar angle is zero) to the condition when the screen is viewed obliquely in the polar angle of 70 degree in a provision that the thickness of the interlayer insulating 106 is changed. Concretely, the thickness of the interlayer insulating film 106 is changed from 190 nm to 350 nm in every 10 nm in various samples, then, the amount of the color shift is measured. As described in FIG. 11, if the thickness of the interlayer insulating film 106 is between 0.19 μm and 0.27 μm, the amount of the shift [symbol] y of y coordinate is in plus direction, thus, the reddish doesn't occur. On the contrary, if the thickness of the interlayer insulating film 106 is 0.28 μm or more, the amount of the shift [symbol] y of y coordinate is in minus direction, thus, the reddish occurs. By the way, when the thickness of the interlayer insulating film 106 is 0.34 μm or more, the amount of the shift [symbol] y of y coordinate is in plus direction; however, those thicknesses are not practical from a standpoint of manufacturing process of the liquid crystal display device.

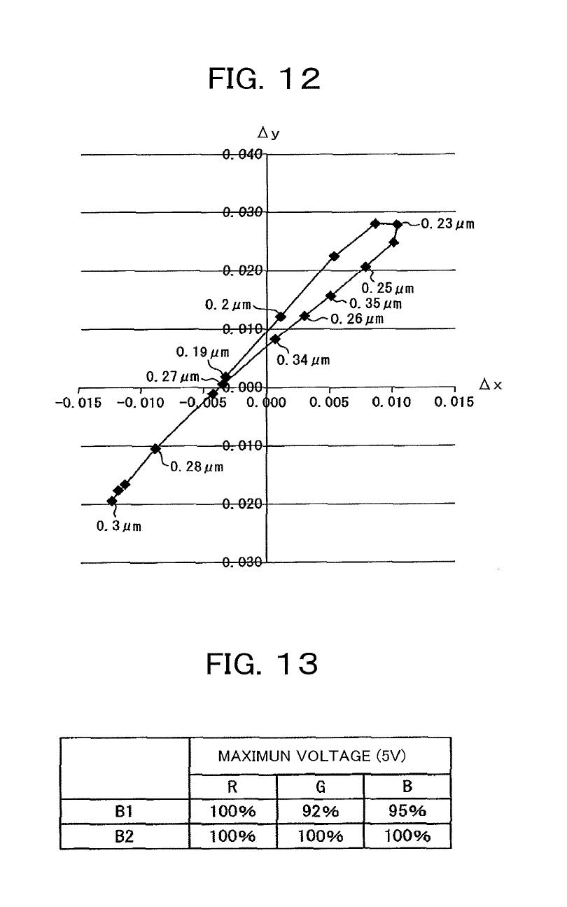

FIG. 12 is a diagram that the table in FIG. 11 is plotted on the coordinates. As described in FIG. 12, if the thickness of the interlayer insulating film 106 is in the region between 0.19 μm and 0.27 μm, the amount of the shift [symbol] y of y coordinate is in the plus area. By the way, the thickness of the interlayer insulating film 106 is not the only factor that affects color shift according to the polar angle; however, selecting the thickness of the interlayer insulating film in the region between 0.19 μm and 0.27 μm, the shift of y coordinate can be made in the plus direction, thus, the condition that the reddish doesn't occur can be attainable.

### (2) Driving Voltage to Each of the RGB Pixels

Next, the driving voltage for subpixels of R, G, B is explained. In the IPS type liquid crystal display device in the normally black type, if the pixel is formed by the subpixels of R, G, B, a maximum driving voltage of the video signals is applied to each of the subpixels when a white is displayed. Namely, if the maximum driving voltage of the liquid crystal display device is 5 volt, 5 volt is applied to each of the subpixels when a white is displayed.

However, there is a measure that maximum voltages to each of the subpixels are adjusted to get the intended color temperature of the white. As described above, provided the maximum driving voltage of the liquid crystal display device is 5 volt, there is a case a voltage of less than the maximum voltage of 5 volt is applied to one or two of subpixels of R, G and B to display a white. FIG. 13 is an example of the driving voltage.

The sample B1 is an example that the driving voltages are adjusted. If the opening ratio is the same in subpixels of R, G, B, generally a brightness of the green pixel becomes highest, B1 is an example that this circumstance is considered. Concretely, provided the maximum driving voltage is 5 volt, for the purpose of displaying an intended white, the driving voltage for the red pixel is 5V×1=5V; the driving voltage for the green pixel is 5V×0.92=4.6V; the driving voltage for the blue pixel is 5V×0.95=4.7V. On the other hand, the sample B2 is the case such adjustments are not applied to display a white, namely, the maximum voltage of 5 volt is applied to all the subpixels.

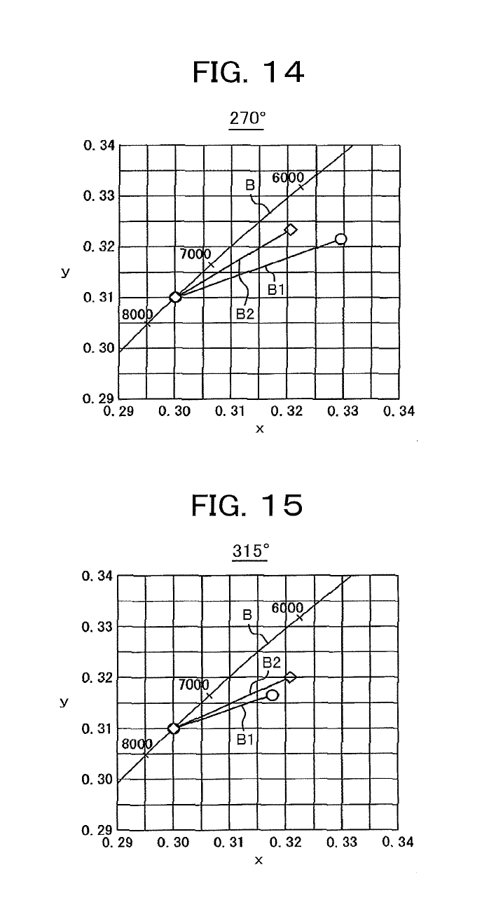

FIG. 14 is a diagram that shows the change of color coordinates when the azimuth is 270 degree between the polar angle is zero and the polar angle is 70 degree for the sample B1 and the sample B2 of FIG. 13. In FIG. 14, B is a trajectory of the black body radiation. When the screen is viewed in the normal direction (the polar angle is zero), the coordinates is x=0.300, y=0.310, namely, the white is correctly displayed in all the samples. On the contrary, when the screen is viewed in the polar angle of 70 degree, the case that the driving voltage adjustment is not applied (sample B2) is nearer to the black body radiation B than the case that the driving voltage adjustment is applied (sample B1); thus, the reddish is less in the case that the driving voltage adjustment is not applied.

FIG. 15 is a diagram that the same evaluation is made to the case of the azimuth is 315 degree. As the same as in the case of the azimuth of 270 degree, in the case of the azimuth of 315, too, the case that the driving voltage adjustment is not applied (sample B2) is nearer to the black body radiation B than the case that the driving voltage adjustment is applied (sample B1); thus, the reddish is less in the case that the driving voltage adjustment is not applied.

Therefore, to suppress the reddish when the screen is viewed in an oblique angle, it is preferable to countermeasure by the structure of the pixels to acquire the intended white color temperature not relying on the adjustment of the driving voltages.

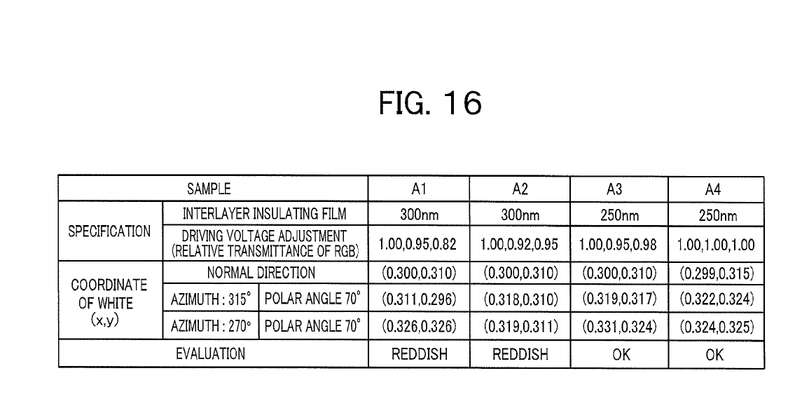

FIG. 16 is a table that shows the evaluation of the coordinates of colors in relation with the factor of driving voltage adjustment amounts in addition to the factors listed in FIG. 6. The thickness of the interlayer insulating film 106 is 300 nm in the samples A1 and A2; the thickness of the interlayer insulating film 106 is 250 nm in the samples A3 and A4. In the table of FIG. 16, the row of “driving voltage adjustment” means the voltage ratios for the green pixel and the blue pixel with respect to the voltage for the red pixel to acquire the intended white. Numbers in each of the columns are, from left to right, of the red pixel, of the green pixel and of the blue pixel. Namely, the value of voltage ratio corresponds to the value of transmittance in each of the pixels.

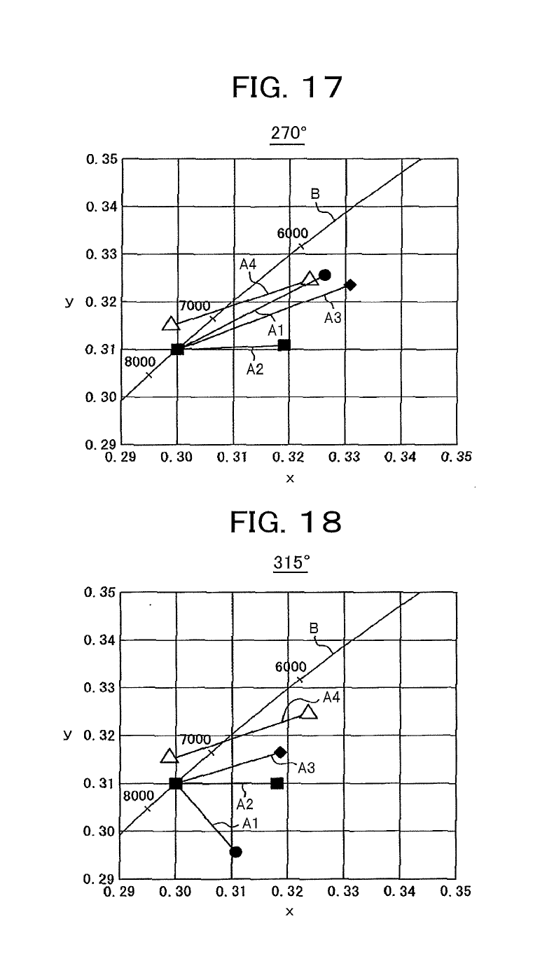

FIG. 17 is a diagram that shows the change of color coordinates between the polar angle is zero and the polar angle is 70 degree when the azimuth is 270 degree. FIG. 17 is a diagram corresponding to the table of FIG. 16. The reddish is acceptable level except sample A2 at the azimuth of 270 degree.

FIG. 18 is a diagram that shows the change of color coordinates between the polar angle is zero and the polar angle is 70 degree when the azimuth is 315 degree. FIG. 18 is a diagram corresponding to the table of FIG. 16. The reddish is acceptable level except samples A1 and A2 at the azimuth of 315 degree.

As described in FIGS. 17 and 18, the samples A3 and A4 satisfy the requirement of the reddish level at the azimuth 270 degree and 315 degree. Specifically, the sample A4 is in the least shift from the trajectory B of the black body radiation at both of the azimuth angles of 270 degree and 315 degree in the polar angle 70. Thus, it is best to countermeasure the reddish by the thickness of the interlayer insulating film but not relying on the driving voltage adjustment.

As explained above, the color shift between when the screen is viewed in the normal direction (the polar angel is zero) and when the screen is viewed in an oblique angle can be decreased by controlling the thickness of the interlayer insulating film.

What is claimed is:

1. A liquid crystal display device comprising:
a liquid crystal layer is sealed between a first substrate and a second substrate,
a first insulating film including a silicon oxide film (SiO) on the first substrate,
a second insulating film including a silicon nitride film (SiN) covering the first insulating film,
a third insulating film including a silicon oxide film (SiO) covering the second insulating film,
wherein a thickness of the second insulating film is between 190 nm and 270 nm.

2. The liquid crystal display device according to claim 1,
wherein the thickness of the second insulating film is between 210 nm and 250 nm.

3. The liquid crystal display device according to claim 1,
wherein a refractive index of the second insulating film is bigger than a refractive index of the first insulating film and of the third insulting film.

4. The liquid crystal display device according to claim 1,
wherein the refractive index of the second insulating film is bigger than the refractive index of the first insulating film or the refractive index of the first insulating film in 0.3 or more.

5. The liquid crystal display device according to claim 1,
wherein a fourth insulating film including a silicon oxide (SiO) is formed between the first insulating film and the first substrate.

6. The liquid crystal display device according to claim 1,
wherein maximum driving voltages for a red pixel, for a green pixel and for a blue pixels are same.

7. A liquid crystal display device comprising:
a liquid crystal layer is sealed between a first substrate and a second substrate,
a first surface of the second substrate contacts a liquid crystal layer,
a second surface of the second surface is a reverse side of the first surface,
a polar angle is zero when a screen is viewed in a normal direction and the polar angle increases according to a degree of deviation of viewing angle from the normal direction,
an azimuth angle is zero in a direction of 3 O'clock on the screen and the azimuth angle increases in a counter clock direction on the screen, wherein provided a white color is displayed,
a coordinate of y in chromaticity coordinates is y1 of the white color when the screen is viewed in a direction of the polar angle is zero,
a coordinate of y in chromaticity coordinates is y2 of the white color in a direction of the polar angle is 70 degree and the azimuth is 270 degree,
wherein y1 is in a plus side compared with y2.

8. A liquid crystal display device comprising:
a liquid crystal layer is sealed between a first substrate and a second substrate,
a first surface of the second substrate contacts a liquid crystal layer,
a second surface of the second surface is a reverse side of the first surface,
a polar angle is zero when a screen is viewed in a normal direction and the polar angle increases according to a degree of deviation of viewing angle from the normal direction,
an azimuth angle is zero in a direction of 3 O'clock on the screen and the azimuth angle increases in a counter clock direction on the screen, wherein provided a white color is displayed,
a coordinate of y in chromaticity coordinates is y1 of the white color in a direction of the polar angle is zero,
a coordinate of y in chromaticity coordinates is y2 of the white color when the screen is viewed in a direction of the polar angle is 70 degree and the azimuth is 315 degree,
wherein y1 is in a plus side compared with y2.

9. The liquid crystal display device according to claim 7,
a first insulating film including a silicon oxide film (SiO) on the first substrate,
a second insulating film including a silicon nitride film (SiN) covering the first insulating film,
a third insulating film including a silicon oxide film (SiO) covering the second insulating film,
wherein a thickness of the second insulating film is between 190 nm and 270 nm.

10. The liquid crystal display device according to claim 8,
a first insulating film including a silicon oxide film (SiO) on the first substrate,
a second insulating film including a silicon nitride film (SiN) covering the first insulating film,
a third insulating film including a silicon oxide film (SiO) covering the second insulating film,
wherein a thickness of the second insulating film is between 190 nm and 270 nm.
